(19) United States
(12) Patent Application Publication
(10) Pub. No.: US 2016/0153637 A1
(43) Pub. Date: Jun. 2, 2016

(54) MARKER LAMP

(71) Applicant: KOITO MANUFACTURING CO., LTD., Minato-ku, Tokyo (JP)

(72) Inventor: Hironori Tsukamoto, Shizuoka (JP)

(73) Assignee: KOITO MANUFACTURING CO., LTD., Minato-ku, Tokyo (JP)

(21) Appl. No.: 14/899,876

(22) PCT Filed: Jun. 6, 2014
(86) PCT No.: PCT/JP2014/065039

§ 371 Date: Dec. 18, 2015

(30) Foreign Application Priority Data
Jun. 18, 2013 (JP) 2013-127749

(51) Int. Cl. F21S 8/10; B60Q 1/30; B60Q 1/44

(52) U.S. Cl. CPC F21S 48/217; B60Q 1/44; B60Q 1/30; F21Y 2101/02; F21Y 2113/005

(57) ABSTRACT

A marker lamp mounted on a vehicle includes a light source unit (7) including an organic EL element (10). The light source unit (7) includes a first light emitting part (12a) for emitting red light of a first wavelength band and a second light emitting part (12b) for emitting red light of a second wavelength band different from the first wavelength band.

### CROSS-REFERENCE TO RELATED APPLICATIONS

The present application is a national stage application of PCT/JP2014/065039, and claims priority from Japanese Patent Application No. 2013-127749 filed on Jun. 18, 2013, the contents of which are incorporated herein in their entirety.

### BACKGROUND

1. Technical Field

The present invention relates to a marker lamp mounted on a vehicle.

2. Related Art

On the rear part of a vehicle, a marker lamp to be called a tail lamp or a stop lamp is mounted in order to avoid the rear-end collision of a following vehicle (e.g., see Patent Document 1). The tail lamp is turned on during night driving or the like. The stop lamp is turned on during brake operation. There has been also known a structure that the light intensity of the tail lamp is increased in conjunction with the brake operation, and thus, the tail lamp serves as a stop lamp.

### CITATION LIST

### Patent Document

Patent Document 1: Japanese Patent Laid-Open Publication No. 2006-73289

### SUMMARY

The marker lamp as described above exhibits a red color at the time of lighting of a light source. However, since the wavelength dependency of color vision is different from person to person, there is a case that even the same red is perceived to be different from person to person. Namely, although the color is good for a certain person, the color is not necessarily good for another person.

Therefore, a technique according to one or more embodiments of the present invention is capable of meeting various needs for the color of a marker lamp.

One or more embodiments of the present invention provides a marker lamp mounted on a vehicle. The marker lamp includes a light source unit having at least one semiconductor light emitting element. The light source unit includes a first light emitting part configured to emit red light of a first wavelength band and a second light emitting part configured to emit red light of a second wavelength band different from the first wavelength band.

According to this configuration, it is possible to emit a spread red color even in the case of using, as a light source, a semiconductor light emitting element whose emission wavelength band tends to be narrow. Therefore, it is easy to meet various needs based on the wavelength dependency of color vision different for each user or the difference in preference for color.

The first wavelength band may include a wavelength equal to or greater than 620 nm, and the second wavelength band may include a wavelength less than 620 nm.

The red light having the wavelength equal to or greater than 620 nm, which is emitted from the first light emitting part, is recognized as a darker red color. However, this wavelength is less likely to be recognized to a color weak (red blind) person. Therefore, it may be difficult for the color weak (red blind) person to visually recognize the lighting of the first light emitting part. According to the above configuration, the second light emitting part emits red light having the wavelength less than 620 nm. Since this wavelength can be easily recognized by the color weak person, the lighting of the marker lamp can be securely recognized. On the other hand, a plurality of types of light emitting parts for emitting light in different colors are recognized to the normal color vision person. Therefore, for the person having various color visions, the safety and the diversity of emission aspect can be securely compatible.

The first light emitting part and the second light emitting part may be configured to form a predetermined geometric pattern. Additionally or alternatively, the first light emitting part and the second light emitting part may be arranged on the basis of a predetermined repetition rule.

According to these configurations, it is possible to meet the needs for various light emitting aspects.

The semiconductor light emitting element may be an organic EL element.

In this case, it is difficult to recognize a change in color at the boundary between different light emitting parts, and thus, a change in the natural color can be achieved. Further, it is possible to easily form a surface light emitting region of an arbitrary shape.

### BRIEF DESCRIPTION OF DRAWINGS

FIGS. 1A-1B are views for explaining a configuration of a marker lamp according to one or more embodiments of the present invention.

FIGS. 2A-2B are views schematically showing a configuration of a light source unit included in the marker lamp.

FIGS. 3A-3C are views showing a modified example of the light source unit.

### DETAILED DESCRIPTION

Hereinafter, embodiments of the present invention will be described in detail with reference to the accompanying drawings. In each of the drawings used in the following description, the scale of each member is suitably changed in order to have a recognizable size. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

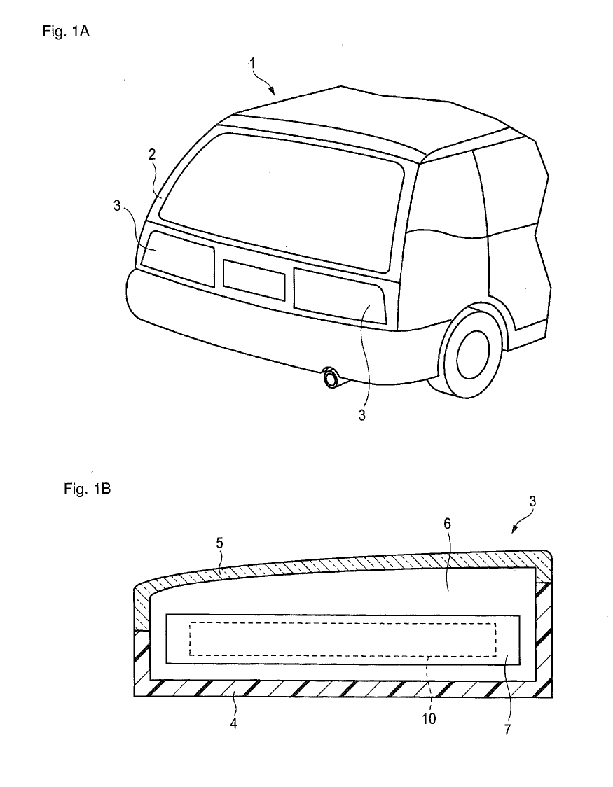

FIG. 1A is a perspective view schematically showing the rear part of a vehicle 1. A marker lamp 3 according to one or more embodiments of the present invention is mounted to a back door 2 for opening and closing a cabin space in the rear part of the vehicle. The marker lamp 3 is configured to also serve as a tail lamp and a stop lamp. Namely, the marker lamp 3 is configured to be turned on in conjunction with a headlamp during night driving or during bad weather and to emit light at higher light intensity when a brake is actuated.

FIG. 1B is a horizontal sectional view schematically showing a configuration of the marker lamp 3. In the marker lamp 3, a translucent cover 5 is mounted to a housing 4 to define a lamp chamber 6. The housing 4 is made of, for example, resin. The translucent cover 5 is made of, for example, resin. A light source unit 7 is accommodated in the lamp chamber 6. The light source unit 7 has an organic EL element 10 therein. The light emitted from the organic EL element 10 is visible at the rear of the vehicle 1 through the translucent cover 5.

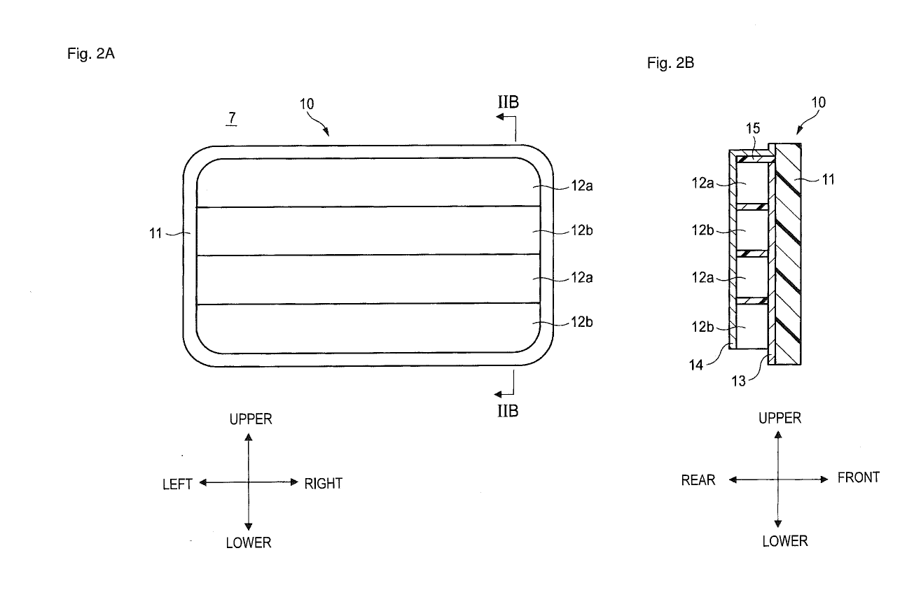

FIG. 2A is a front view schematically showing a configuration of the organic EL element 10. FIG. 2B is a longitudinal sectional view taken along a line IIB-IIB in FIG. 2A. The organic EL element 10 includes a substrate 11, a first emitting part 12a, a second light emitting part 12b, a positive electrode 13, a negative electrode 14, and an insulation member 15. The positive electrode 13 and the negative electrode 14 are not shown in FIG. 2A.

The first emitting part 12a is configured to emit red light having a wavelength equal to or greater than 620 nm by the application of voltage. The second light emitting part 12b is configured to emit red light having a wavelength less than 620 nm by the application of voltage. As shown in FIG. 2A, each of the first emitting part 12a and the second light emitting part 12b has an elongated shape extending in the lateral direction of the vehicle 1. Further, two first light emitting parts 12a and two second light emitting parts 12b are alternately arranged in the vertical direction of the vehicle.

As shown in FIG. 2B, the first emitting parts 12a and the second light emitting parts 12b are fixed to the substrate 11 in a state of being sandwiched between the positive electrode 13 and the negative electrode 14 thereof. The insulation members 15 for short-circuit prevention are interposed between the positive electrode 13 and the negative electrode 14. The position of the positive electrode 13 and the position of the negative electrode 14 may be reversed. As voltage is applied between the positive electrode 13 and the negative electrode 14 from a power source (not shown), the first light emitting parts 12a and the second light emitting parts 12b emit the red light of a predetermined wavelength, as described above.

Specifically, the light source unit 7 includes the first light emitting part 12a configured to emit red light of a first wavelength band and the second light emitting part 12b configured to emit red light of a second wavelength band different from the first wavelength band. According to this configuration, it is possible to emit a spread red color even in the case of using, as a light source, a semiconductor light emitting element whose emission wavelength band tends to be narrow. Therefore, it is easy to meet various needs based on the wavelength dependency of color vision different for each user or the difference in preference for color.

The red light having the wavelength equal to or greater than 620 nm, which is emitted from the first light emitting part 12a, is recognized as a darker red color. However, this wavelength is less likely to be recognized to a color weak (red blind) person. Therefore, it may be difficult for the color weak (red blind) person to visually recognize the lighting of the first light emitting part 12a. For this reason, the second light emitting part 12b is configured to emit red light having the wavelength less than 620 nm. Since this wavelength can be easily recognized by the color weak person, the lighting of the marker lamp 3 can be securely recognized. On the other hand, two types of light emitting part for emitting light in different colors are recognized to the normal color vision person. Therefore, for the person having various color visions, the safety and the diversity of emission aspect can be securely compatible.

Further, since the organic EL element 10 is used as the semiconductor light emitting element, it is difficult to recognize a change in color at the boundary between different light emitting parts, and thus, a change in the natural color can be achieved.

The above embodiments are intended to facilitate understanding of the present invention and should not be construed as limiting the present invention. It is apparent that the present invention can be modified and improved without departing from the gist thereof and includes the equivalent thereof.

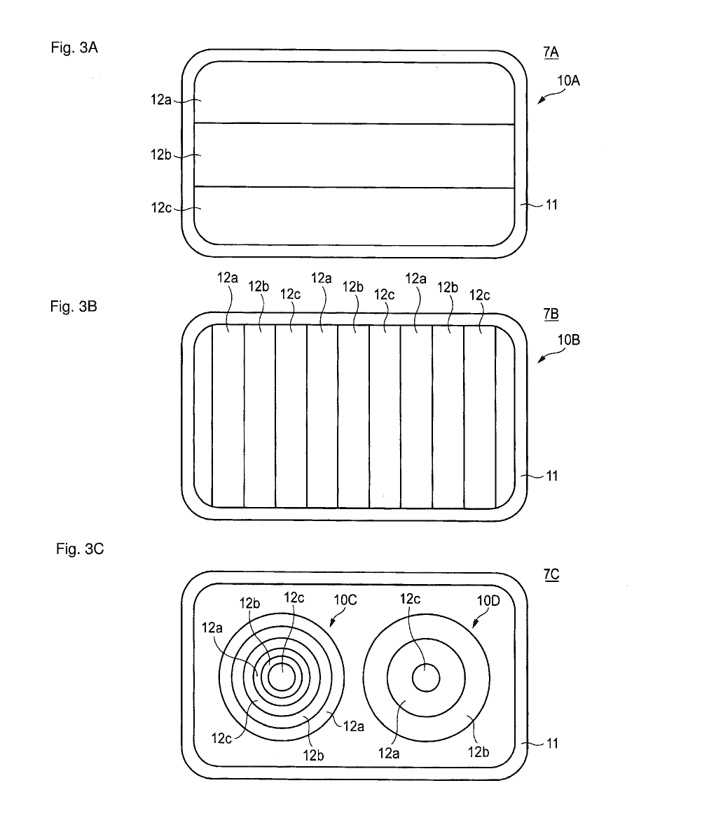

The wavelength band of the red light emitted from the light source unit 7 is not limited to two types. For example, a light source unit 7A according to a first modified example shown in FIG. 3A includes an organic EL element 10A which has a first light emitting part 12a for emitting red light of a first wavelength band, a second light emitting part 12b for emitting red light of a second wavelength band, and a third light emitting part 12c for emitting red light of a third wavelength band. According to this configuration, the change in color can be richer.

The first wavelength band, the second wavelength band, and the third wavelength band can be appropriately determined within the range of about 610 nm to 630 nm. Here, it is noted that any one of the first light emitting part 12a, the second light emitting part 12b and the third light emitting part 12c is required to emit red light having the wavelength less than 620 nm. Of course, the number of the wavelength band can be four types or more.

The extending direction of each light emitting part is not necessarily required to be the lateral direction of the vehicle 1. For example, a light source unit 7B according to a second modified example shown in FIG. 3B includes an organic EL element 10B where a first light emitting part 12a, a second light emitting part 12b and a third light emitting part 12c have an elongated shape extending in the vertical direction of the vehicle 1 and are repeatedly arranged in this order in the lateral direction of the vehicle 1. The requirement for the wavelength of red light emitted from the first light emitting part 12a, the second light emitting part 12b and the third light emitting part 12c is the same as the first modified example described with reference to FIG. 3A.

According to this configuration, red gradation, which is periodically changed at the time of the lighting of the marker lamp 3, is visible. Repetition rules can be appropriately determined in accordance with the needs of a user or the specifications of the vehicle 1.

The shape of each light emitting part is not limited to the elongated shape extending in the lateral direction or the vertical direction of the vehicle 1. By using the property of an organic EL element which is easy to form a surface light emitting region of an arbitrary shape, a geometric pattern, which is easy to appeal to the visual sense of a user, can be formed.

For example, a light source unit 7C according to a third modified example shown in FIG. 3C includes an organic EL element 10C and an organic EL element 10D. Each of the organic EL element 10C and the organic EL element 10D is configured so that a first light emitting part 12a, a second light emitting part 12b and a third light emitting part 12c have an annular shape and are concentrically arranged. The arrangement rules are different in the organic EL element 10C and the organic EL element 10D. The requirement for the wavelength of red light emitted from the first light emitting part 12a, the second light emitting part 12b and the third light emitting part 12c is the same as the first modified example described with reference to FIG. 3A.

The semiconductor light emitting element included in the light source unit is not limited to the organic EL element. A light emitting diode or a laser diode can be used, so long as these are able to form the first light emitting part for emitting red light of the first wavelength band and the second light emitting part for emitting red light of the second wavelength band.

In this case, a plurality of light emitting diodes or a plurality of laser diodes may be arranged in accordance with the shape of each light emitting part. Alternatively, the red light emitted from the light emitting diode or laser diode arranged at a predetermined place may be guided to the rear of the vehicle 1 by using a light guide member having the above shape. Contrast of color may be adjusted by providing a structure for inducing a light scattering on the light guide member or the translucent cover.

The shape of the marker lamp 3 and the position thereof at the rear part of the vehicle 1, the shape and number of the light source unit 7, and the shape and number of the organic EL element 10 can be appropriately determined in accordance with the specifications of the vehicle 1.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A marker lamp mounted on vehicle comprising:
a light source unit comprising:
at least one semiconductor light emitting element,
a first light emitting part configured to emit red light of a first wavelength band, and
a second light emitting part configured to emit red light of a second wavelength band different from the first wavelength band.

2. The marker lamp according to claim 1,
wherein the first wavelength band includes a wavelength equal to or greater than 620 nm, and
wherein the second wavelength band includes a wavelength less than 620 nm.

3. The marker lamp according to claim 1, wherein the first light emitting part and the second light emitting part form a predetermined geometric pattern.

4. The marker lamp according to claim 1, wherein the first light emitting part and the second light emitting part are arranged on the basis of a predetermined repetition rule.

5. The marker lamp according to claim 1, wherein the semiconductor light emitting element is an organic EL element.

6. The marker lamp according to claim 2, wherein the first light emitting part and the second light emitting part form a predetermined geometric pattern.

7. The marker lamp according to claim 2, wherein the first light emitting part and the second light emitting part are arranged on the basis of a predetermined repetition rule.

8. The marker lamp according to claim 3, wherein the first light emitting part and the second light emitting part are arranged on the basis of a predetermined repetition rule.

9. The marker lamp according to claim 2, wherein the semiconductor light emitting element is an organic EL element.

10. The marker lamp according to claim 3, wherein the semiconductor light emitting element is an organic EL element.

11. The marker lamp according to claim 4, wherein the semiconductor light emitting element is an organic EL element.
